(19) United States
(12) Patent Application Publication
(10) Pub. No.: US 2026/0311297 A1
(43) Pub. Date: Oct. 8, 2026

(54) IMAGE PROCESSING APPARATUS, MOBILE ROBOT, SHADOW CORRECTION METHOD AND NON-TRANSITORY COMPUTER-READABLE RECORDING MEDIUM ENCODED WITH SHADOW CORRECTION PROGRAM

(71) Applicant: Konica Minolta, Inc., Tokyo (JP)

(72) Inventors: Yasuyuki KAMAI, Tokyo (JP); Tomoyoshi YUKIMOTO, Okazaki-shi (JP)

(21) Appl. No.: 19/639,925

(22) Filed: Apr. 6, 2026

(30) Foreign Application Priority Data
Apr. 8, 2025 (JP) 2025-063798

(51) Int. Cl. G06T 5/20; G06T 7/70; G06V 10/60

(52) U.S. Cl. CPC G06T 5/20; G06T 7/70; G06V 10/60

(57) ABSTRACT

An image processing apparatus includes a hardware processor, wherein the hardware processor acquires an image obtained by imaging an object, with the object having an upper surface and having an arc-shaped opening formed in a portion of the upper surface, and corrects a shadow region appearing as a shadow in the acquired image.

### CROSS-REFERENCE TO RELATED APPLICATIONS

The entire disclosure of Japanese patent Application No. 2025-063798 filed on Apr. 8, 2025, is incorporated herein by reference in its entirety.

### BACKGROUND OF THE INVENTION

### Technical Field

The present invention relates to an image processing apparatus, a mobile robot, a shadow correction method, and a non-transitory computer-readable recording medium encoded with a shadow correction program. In particular, the present invention relates to an image processing apparatus that processes an image obtained by imaging an object using a camera, a mobile robot including the image processing apparatus, a shadow correction method executed by the image processing apparatus, and a non-transitory computer-readable recording medium encoded with a shadow correction program that causes a computer to execute the shadow correction method.

### Description of Related Art

There is a robot including a camera and a manipulator. The manipulator includes an articulated robot and a controller. This robot identifies position and orientation of an object by analyzing an image obtained by imaging the object using the camera. Then, the controller controls the articulated robot and causes the articulated robot to grip a predetermined portion of the object.

In a process of identifying the position and orientation of the object based on the image, in a case where a shadow appears in the image, a shadow portion may be erroneously extracted as a portion of the object. Therefore, it is preferable that no shadow is present in the image.

The camera receives light reflected from the object and outputs an image obtained by photoelectrically converting the received light. In a case where the robot does not move, a relative position of the camera and a light source does not change. Therefore, it is preferable to prevent a shadow from appearing on the object by adjusting a position of the light source, etc.

Further, a technique for removing a shadow from an image before a process of identifying position and orientation of an object based on the image has been known. For example, Japanese Patent Application Publication No. 2015-90560 describes an image processing apparatus that is characterized in comprising an image acquirer that acquires an image including an object, a holder that holds model information of the object, an acquirer that acquires approximate position and orientation of the object included in the image, an estimator that estimates information regarding a shadow region of the object in the acquired image, a corrector that corrects the approximate position and orientation based on the estimated information regarding the shadow region, and a deriver that derives position and orientation of the object in the image based on the approximate position and orientation corrected by the corrector, and the model information, wherein the holder further holds a positional relationship between a projector that projects light to the object and an imager that captures the image, and the estimator estimates a direction in which a shadow is located with respect to the position of the object based on the held positional relationship and the approximate position and orientation.

On the other hand, in a case of a mobile robot including a movement mechanism, a relative position of a camera and a light source changes. In this case, a shadow appearing in an image changes as the relative position of the camera and the light source changes. Therefore, it is difficult to identify an object based on an image captured by the camera included in the mobile robot.

### SUMMARY OF THE INVENTION

According to one aspect of the present invention, an image processing apparatus includes a hardware processor, wherein the hardware processor acquires an image obtained by imaging an object, with the object having an upper surface and having an arc-shaped opening formed in a portion of the upper surface, and corrects a shadow region appearing as a shadow in the acquired image.

According to another aspect of the present invention, a mobile robot includes the above-mentioned image processing apparatus, and an imager that images an object, a manipulator that grips the object, and an apparatus hardware processor, wherein the apparatus hardware processor provides, to a learning model, a correction image obtained after a shadow region is corrected by the image processing apparatus, and determines a position of an opening in the correction image.

According to yet another aspect of the present invention, a shadow correction method causes an image processing apparatus to execute an image acquiring step of acquiring an image obtained by imaging an object, with the object having an upper surface and having an arc-shaped opening formed in a portion of the upper surface, and a correcting step of correcting a shadow region appearing as a shadow in the acquired image.

According to yet another aspect of the present invention, a non-transitory computer-readable recording medium is encoded with a shadow correction program that causes a computer to execute the above-mentioned shadow correction method.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram illustrating one example of the overview of a mobile robot in one embodiment of the present invention;

FIG. 2 is a perspective view illustrating part of a seat track;

FIG. 3 is a plan view illustrating part of the seat track;

FIG. 4 is a diagram illustrating one example of a shadow of a top plate cast on a bottom surface of a bottom plate;

FIG. 5 is a diagram illustrating one example of a result of extraction of a circular cutout portion from an image output by a camera;

FIG. 6 is a diagram illustrating direct light;

FIG. 7 is a diagram illustrating scattered light;

FIG. 8 is a first diagram schematically illustrating the positional relationship among irradiation light, direct light obtained by reflection from a first tapered surface, and the camera, in a horizontal plane;

FIG. 9 is a second diagram schematically illustrating the positional relationship among the irradiation light, the direct light obtained by reflection from the first tapered surface, and the camera, in the horizontal plane;

FIG. 10 is a first diagram illustrating part of the image output by the camera in an enlarged manner;

FIG. 11 is a second diagram illustrating part of the image output by the camera in an enlarged manner;

FIG. 12 is a block diagram illustrating the outline of the hardware configuration of an image processing apparatus;

FIG. 13 is a block diagram illustrating one example of functions of a central processing unit (CPU) included in the image processing apparatus in the present embodiment;

FIG. 14 is a diagram illustrating one example of detailed functions of an image processor;

FIG. 15 is a diagram for explaining determination and correction of a shadow region;

FIG. 16 is a diagram for explaining determination and correction of a shadow region in a modification example;

FIG. 17 is a flowchart illustrating one example of a robot control process in the present embodiment; and

FIG. 18 is a flowchart illustrating one example of a flow of a shadow correction process.

### DETAILED DESCRIPTION

Hereinafter, one or more embodiments of the present invention will be described with reference to the drawings. However, the scope of the invention is not limited to the disclosed embodiments.

A mobile robot according to embodiments of the present invention will be described below with reference to the drawings. In the following description, the same components are denoted by the same reference numerals. Their names and functions are the same. Therefore, a detailed description thereof will not be repeated.

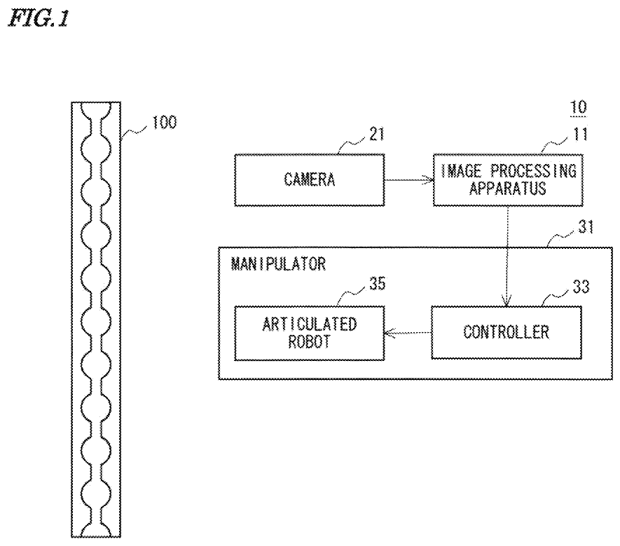

FIG. 1 is a block diagram illustrating one example of the overview of a mobile robot in one embodiment of the present invention. With reference to FIG. 1, the mobile robot 10 includes an image processing apparatus 11, a camera (or an imager) 21, and a manipulator 31. The manipulator 31 includes an articulated robot 35 that grips an object, and a controller 33 that controls the articulated robot 35. The articulated robot 35 is a multi-joint robot and has a hand for gripping the object.

In the mobile robot 10, the articulated robot 35 grips a seat track 100. The mobile robot 10 grips a predetermined portion of the seat track 100 with the hand of the articulated robot 35.

The camera 21 captures an image of a subject, and outputs the captured image to the image processing apparatus 11. The camera 21 has a lens and photoelectric conversion elements. Light emitted from a light source is reflected from the subject. The lens collects the light obtained by reflection from the subject, and guides the light to the photoelectric conversion elements. The photoelectric conversion elements output electrical signals corresponding to amounts of received light. The plurality of photoelectric conversion elements are aligned in a two-dimensional manner. The camera 21 generates the image including a plurality of pixels respectively corresponding to the plurality of photoelectric conversion elements. The image includes luminance values respectively corresponding to the plurality of pixels aligned in a two-dimensional manner. A luminance value indicates an electrical signal output by a corresponding photoelectric conversion element. In the present embodiment, the object serving as the subject of the camera 21 is the seat track 100.

The camera 21 is a time-of-flight (ToF) camera. The camera 21 emits laser light, and the photoelectric conversion elements receive the laser light obtained by reflection from the subject. A distance is calculated based on a period of time from the time when the laser light is emitted to the time when the reflected light is received by the photoelectric conversion elements. The camera 21 outputs, to the image processing apparatus 11, distance data in which a value indicating a distance to the subject for each of the plurality of pixels is set.

Note that a distance sensor may be used separately from the camera 21. The distance sensor is an ultrasonic sensor using an ultrasonic wave. An infrared sensor using infrared rays or a laser sensor using laser light may be used. Alternatively, a camera different from the camera 21 may be used, and a distance may be measured by using the disparity (depth disparity) between the two cameras.

The image processing apparatus 11 receives the image of the object captured and output by the camera 21. The image processing apparatus 11 processes the image received from the camera 21. The image processing apparatus 11 executes a correction process of collecting a shadow region appearing as a shadow in the image received from the camera 21. Further, the image processing apparatus 11 executes a gripping position determination process of determining a gripping position for the manipulator 31 based on a correction image obtained after the correction process. The image processing apparatus 11 outputs, to the controller 33, the determined gripping position and a distance to the gripping position.

The controller 33 controls the articulated robot 35 based on the gripping position and the distance that are received from the image processing apparatus 11. The articulated robot 35 moves the hand to a position defined by the gripping position and the distance, and grips a portion of the object defined by the gripping position and the distance using the hand.

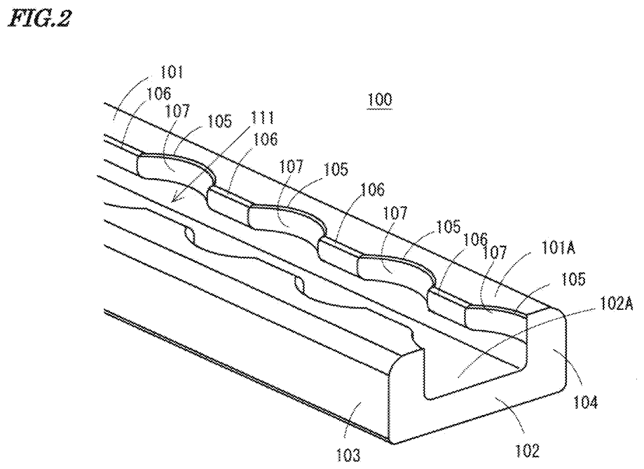

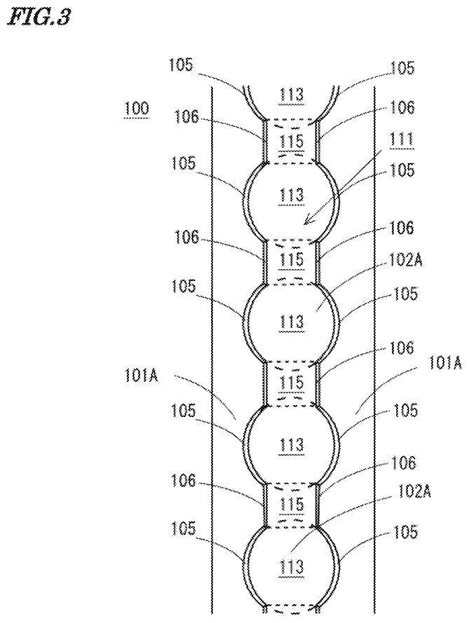

FIG. 2 is a perspective view illustrating part of the seat track. FIG. 3 is a plan view illustrating part of the seat track. With reference to FIGS. 2 and 3, the seat track 100 includes a top plate 101, a bottom plate 102, a first side wall 103, and a second side wall 104. The top plate 101 and the bottom plate 102 have rectangular flat-plate shapes. One end portion of the top plate 101 is connected to one end portion of the bottom plate 102 by the first side wall 103. The other end portion of the top plate 101 opposite to the one end portion of the top plate 101 is connected to the other end portion of the bottom plate 102 opposite to the one end portion of the bottom plate 102. The top plate 101 and the bottom plate 102 are coupled to each other by the first side wall 103 and the second side wall 104 with a predetermined distance therebetween. The top plate 101, the bottom plate 102, the first side wall 103, and the second side wall 104 may be formed as an integrated single piece.

The top plate 101 has an upper surface 101A facing away from the bottom plate 102. The bottom plate 102 has a bottom surface 102A facing toward the top plate 101. A cutout portion 111 penetrating the top plate 101 in an upward-and-downward direction is formed. The cutout portion 111 includes a plurality of circular cutout portions 113 and a plurality of connecting cutout portions 115. The plurality of circular cutout portions 113 all have the same circular shape. The plurality of circular cutout portions 113 are arranged at predetermined intervals in one direction. The connecting cutout portions 115 all have the same rectangular shape. Each of the plurality of connecting cutout portions 115 is arranged between two adjacent circular cutout portions 113 among the plurality of circular cutout portions 113, and connects the two adjacent circular cutout portions 113 to each other. A side surface 107 formed by the cutout portion 111 of the top plate 101 extends in parallel with the upward-and-downward direction.

In an upper edge portion of each side surface 107 formed by each circular cutout portion 113 of the top plate 101, a first tapered surface 105 inclined downwardly from the upper surface 101A of toward a center in a radial direction is formed. In an upper edge portion of each side surface 107 formed by each connecting cutout portion 115 of the top plate 101, a second tapered surface 106 inclined downwardly from the upper surface 101A toward an opposing side surface 107 is formed.

In the seat track 100, the upper surface 101A and the bottom plate 102 are hairline-processed. Further, the first tapered surfaces 105 are mirror-finished. The seat track 100 is made of an aluminum alloy, and is manufactured by cutting the cutout portion 111 of the top plate 101 after processing using an extrusion method, and then chamfering the first tapered surfaces 105 and the second tapered surfaces 106 of the top plate 101. The first tapered surfaces 105 and the second tapered surfaces 106 are mirror-finished.

On a surface of an extruded product, a natural oxide film is often formed, and anodizing is often performed. For this reason, on the surface of the extruded product, a reflectance value is low due to interference or absorption, particularly for visible light and ultraviolet light. Also, the reflectance value of the extruded surface is low because a surface roughness (Ra) of the extruded surface is high, light is diffusely reflected (light scatters). In a case where the first tapered surfaces 105 and the second tapered surfaces 106 are chamfered by CNC machining, their surface roughness (Ra) is low, and specular reflection is a dominant component.

Therefore, reflectance values of the first tapered surfaces 105 and the second tapered surfaces 106 are higher than reflectance values of the upper surface 101A and the bottom surface 102A. The reflectance value of the first tapered surfaces 105 is preferably equal to or higher than 85%. More preferably, the reflectance value of the first tapered surfaces 105 is equal to or higher than 90%. Further, the reflectance values of the upper surface 101A and the bottom surface 102A are preferably equal to or lower than 50%. More preferably, the reflectance values of the upper surface 101A and the bottom surface 102A are equal to or lower than 20%.

In the seat track 100, the upper surface 101A and the bottom surface 102A are arranged with a predetermined distance therebetween. In a case where a light source is present directly above the seat track 100, the top plate 101 does not cast a shadow on the bottom surface 102A. On the other hand, in a case where the light source is located obliquely above the upper surface 101A, light emitted from the light source is blocked by the top plate 101. Therefore, a shadow of the top plate 101 is cast on the bottom surface 102A.

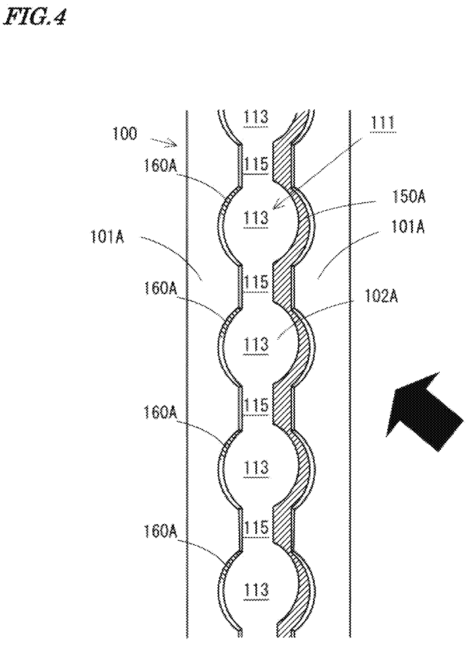

FIG. 4 is a diagram illustrating one example of the shadow of the top plate cast on the bottom surface of the bottom plate. FIG. 4 illustrates the seat track 100 observed with a viewpoint placed right above the seat track 100. With reference to FIG. 4, a traveling direction of irradiation light emitted from the light source is indicated by the black arrow in the diagram. On the bottom surface 102A of the bottom plate 102, a shadow 150A of the top plate 101 is cast on a portion corresponding to the cutout portion 111 formed in the top plate 101. A reflection region 160A that reflects more light than other portions is observed in a portion of each of the plurality of first tapered surfaces 105 respectively corresponding to the plurality of circular cutout portions 113. This reflection region 160A is a region of the first tapered surface 105 that intersects with the traveling direction of the irradiation light at an angle equal to or larger than a predetermined angle.

Here, description is made in regard to a case where positions of the circular cutout portions 113 formed in the top plate 101 are identified based on the image of the seat track 100 illustrated in FIG. 4 and output by the camera 21.

Since the shape of the circular cutout portions 113 formed in the top plate 101 is an arc, when circular portions can be extracted from the image output by the camera 21, the portions of the top plate 101 in which the circular cutout portions 113 are formed can be identified. As a technique for extracting the circular portions from the image output by the camera 21, there is a technology for generating an edge image. The edge image is formed of pixels in which a value of change in luminance value in the image is equal to or higher than a predetermined value.

FIG. 5 is a diagram illustrating one example of a result of extraction of the circular cutout portions from the image output by the camera. With reference to FIG. 5, the image 140 output by the camera 21 includes a partial region 160 corresponding to the reflection region 160A, and a shadow region 150 corresponding to the shadow 150A. In a case where the technique for extracting the circular portions is used, since a contour of the shadow region 150 is an arc, a circular detection shape 151 including the contour of the shadow region 150 is extracted. The detection shape 151 has a size and a position different from those of the circular cutout portion 113. Therefore, in a case where the image 140 output by the camera 21 includes the shadow region 150, it is difficult to extract a portion corresponding to the circular cutout portion 113. The image processing apparatus 11 in the present embodiment corrects the shadow region 150 by processing the image 140 captured by the camera 21. Thus, by using a conventional technique, it is possible to easily extract the circular cutout portion 113 from a correction image obtained after the shadow region 150 of the image 140 is corrected.

Here, reflected light obtained by reflection, from the seat track 100, of the irradiation light emitted from the light source is described. The reflected light includes direct light and scattered light.

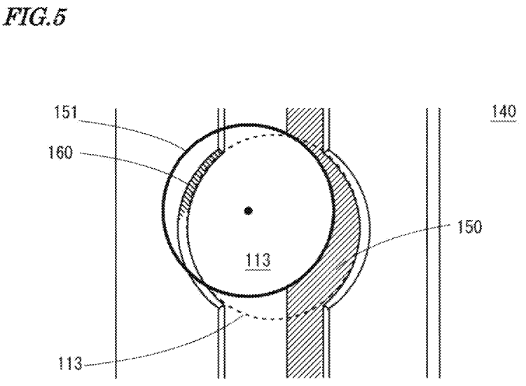

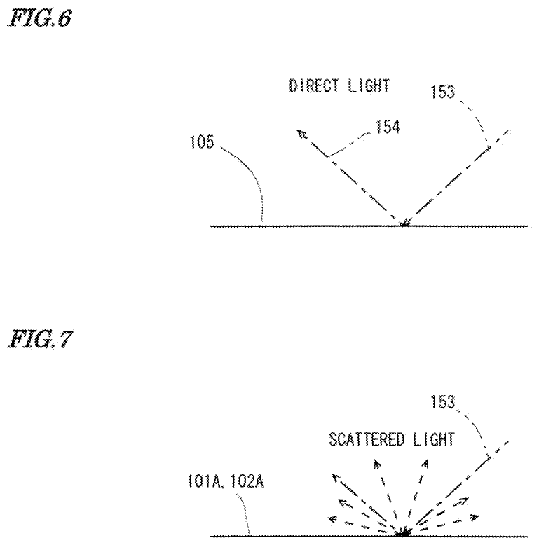

FIG. 6 is a diagram illustrating the direct light. Here, the irradiation light 153 emitted from the light source, and the direct light 154A obtained by reflection, from the first tapered surface 105, of the irradiation light 153 are illustrated. Luminous flux of the direct light 154A remains collimated light similarly to the irradiation light 153. An observed luminance value of the direct light 154A is defined by the following formula (1). The observed luminance value Lθ of the direct light 154A is defined by an illumination luminance value L of the irradiation light 153 and a reflectance value ρ. The observed luminance value Lθ of the direct light 154A is proportional to the reflectance value ρ. In particular, when the reflectance value ρ is 100%, the observed luminance value Lθ of the direct light 154A is equal to the illumination luminance value L and is constant regardless of a distance.

$$L θ = ρ L \qquad ( 1 )$$

Lθ: Observed Luminance Value
L: illumination luminance value
ρ: reflectance value

FIG. 7 is a diagram illustrating the scattered light. Here, the scattered light obtained by reflection from the upper surface 101A or the bottom surface 102A is illustrated. An observed luminance value Lθ of the scattered light is expressed by the following formula (2). The observed luminance value Lθ of the scattered light is proportional to an irradiation-surface illuminance value E (an amount of irradiation light applied per unit area). The irradiation-surface illuminance value E represents an amount of irradiation light applied per unit area, and is inversely proportional to the square of a distance from the light source. θ represents an angle (incident angle) formed between an irradiation direction and a normal to an object plane. Therefore, the observed luminance value Lθ of the scattered light changes according to a change in distance from the light source and a change in incident angle of the irradiation light.

$$L θ = σ / π \times E cos θ \qquad ( 2 )$$

E cos θ: Irradiation-surface Illuminance Value
σ: scattering ratio

Therefore, it is possible to distinguish, based on magnitudes of the observed luminance values, between the direct light 154A obtained by reflection, from the first tapered surface 105, of the irradiation light 153 emitted from the light source, and the scattered light obtained by reflection, from the upper surface 101A or the bottom surface 102A, of the irradiation light 153 emitted from the same light source as that of the direct light 154A.

The first tapered surface 105 formed in the seat track 100 has an arc shape. Therefore, of the first tapered surface 105, the portion from which the irradiation light 153 emitted from the light source is reflected as the direct light 154A is limited to the reflection region 160A.

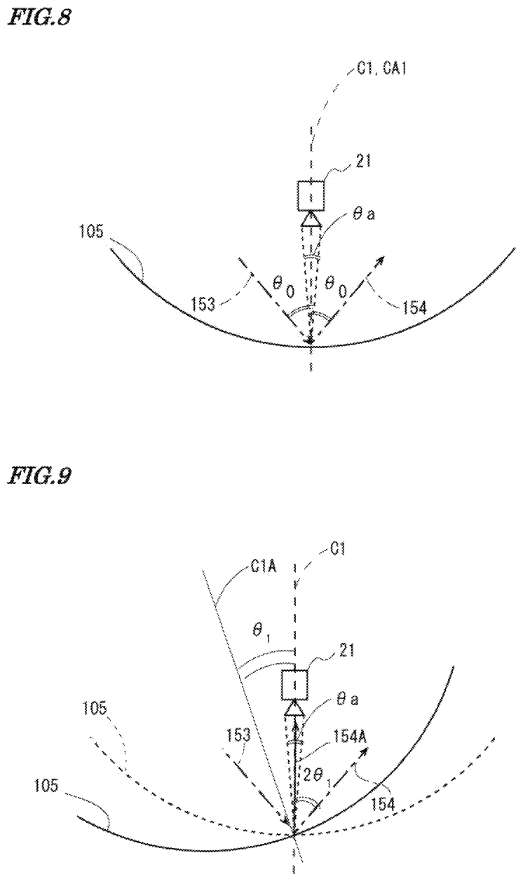

FIG. 8 is a first diagram schematically illustrating the positional relationship among the irradiation light, the direct light obtained by reflection from the first tapered surface, and the camera, in a horizontal plane. With reference to FIG. 8, the relative position of the camera 21 and the first tapered surface 105 is defined at a position where an optical axis C1 of the camera 21 and a normal CA1 of first tapered surface 105 overlap with each other. An observation solid angle θa is defined by an aperture diameter of the lens, which is an optical system element of the camera 21, and a working distance. Light in a range of the observation solid angle θa is received by the camera 21.

The irradiation light 153 emitted from the light source is applied to the first tapered surface 105 at an incident angle θ0, by way of example. The incident angle θ0 is formed by the normal line of the first tapered surface 105 and the irradiation light 153. In this case, the direct light 154A obtained by reflection, from the first tapered surface 105, of the irradiation light 153 is not within the range of the observation solid angle θa of the camera 21. In this case, the direct light 154A obtained by reflection, from the first tapered surface 105, of the irradiation light 153 emitted from the light source is not received by the camera 21.

FIG. 9 is a second diagram schematically illustrating the positional relationship among the irradiation light, the direct light obtained by reflection from the first tapered surface, and the camera, in the horizontal plane. With reference to FIG. 9, a position where an angle formed by the optical axis C1 of the camera 21 and the normal CA1 of the first tapered surface 105 is θ1 is determined as the relative position of the camera 21 and the first tapered surface 105. In this case, the direct light 154A obtained by reflection, from the first tapered surface 105, of the irradiation light 153 is present within the range of the observation solid angle θa of the camera 21. In this case, the direct light 154A obtained by reflection, from the first tapered surface 105, of the irradiation light 153 from the light source is received by the camera 21.

The first tapered surface 105 is formed of a continuous curved surface having different normal directions for respective positions due to an arc shape. The irradiation light externally applied to the first tapered surface 105 have different incident angles for respective portions of the first tapered surface 105. In a case where normals of two portions of the first tapered surface 105 form an angle θ, an angle formed by two reflected light beams obtained by reflection from the two portions is 2θ.

In a case where the light source is spatially fixed, the direct light 154A obtained by reflection, from only a specific position of the first tapered surface 105, coincides with the observation solid angle θa of the camera 21. The region within the first tapered surface 105 where the luminance value is high consists of points whose normal directions satisfy the condition representing the geometric relationship between the light source and the camera 21.

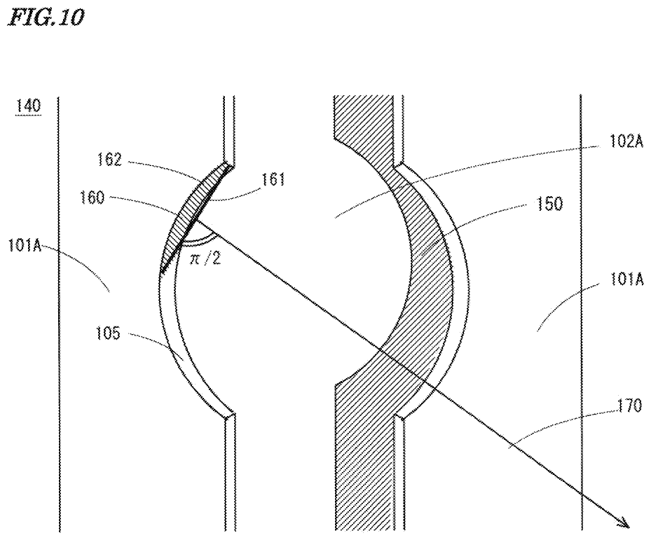

FIG. 10 is a first diagram illustrating part of the image output by the camera in an enlarged manner. With reference to FIG. 10, in the image 140 output by the camera 21, the partial region 160 having a higher luminance value than those of other regions in the first tapered surface 105 is illustrated. The partial region 160 receives the direct light obtained by reflection, from the first tapered surface 105, of the irradiation light 153 emitted from the light source. The upper surface 101A and the bottom surface 102A are hairline-processed. Reflected light obtained by reflection, from the upper surface 101A or the bottom surface 102A, of the irradiation light 153 emitted from the light source is received by the camera 21 as scattered light. Therefore, in the image 140 output by the camera 21, luminance values of portions corresponding to the upper surface 101A and the bottom surface 102A are lower than that of the partial region 160. Thus, it is possible to distinguish the partial region 160 from the upper surface 101A and the bottom surface 102A based on the image 140 output by the camera 21.

The partial region 160 is part of the first tapered surface 105, and includes a boundary with the upper surface 101A as an arc portion 162. A chord 161 connecting ends of the arc portion 162 to each other is identified. A direction orthogonal to the chord 161 is identified as a direction parallel to the irradiation light 153. Further, based on the shape of the seat track 100, out of two directions orthogonal to the chord 161, a direction directed toward the center of the arc portion 162 is identified as a light source direction 170. Because the first tapered surface 105 is inclined downwardly from the upper surface 101A toward the center of the circular cutout portion 113, a direction directed toward the center of the arc portion 162 may be identified as the light source direction 170. Note that, although this does not apply to the seat track 100 in the present embodiment, in a case where a tapered surface is inclined downwardly and outwardly from the upper surface 101A, an outward direction of the arc portion 162 may be identified as the light source direction 170.

The partial region 160 may include an end portion of the circular cutout portion 113. The circular cutout portion 113 is connected to the connecting cutout portion 115 in the end portion. The end portion of the circular cutout portion 113 is connected to the connecting cutout portion 115.

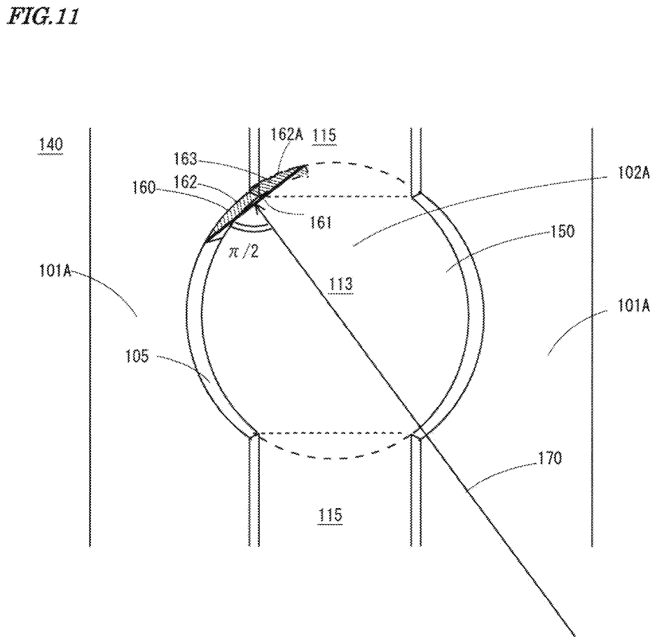

FIG. 11 is a second diagram illustrating part of the image output by the camera in an enlarged manner. The difference from FIG. 10 is that the partial region 160 includes the end portion of the circular cutout portion 113. The partial region 160 includes an arc portion 162A. In this case, the partial region 160 is extended toward the end portion by an undetected region 163. As one example of an extending method, a shape of the undetected region 163 is determined based on a shape of the partial region 160. The shape of the undetected region 163 is determined such that a pixel having the highest luminance value among pixels in the partial region 160 is located at a center point. A reference axis passing through the center and parallel to a radial direction of the arc portion 162 is defined. Then, a point, which is symmetric to an end portion of the partial region 160 with respect to the reference line, is determined as an end portion of the undetected region 163. The arc portion 162 is extended to the end portion of the undetected region 163, so that the arc portion 162A is defined. A chord 161 that connects, to an end portion of the arc portion 162A, an end portion of the arc portion 162 opposite to the arc portion 162A is defined.

Note that a reference axis passing through the center of the partial region 160 and parallel to the radial direction of the arc portion 162 may be determined. Further, in a case where a size of the partial region 160 is equal to or smaller than a predetermined threshold value, the partial region may be extended.

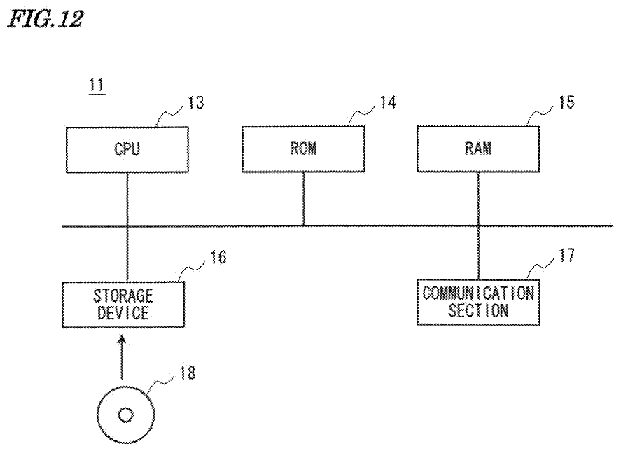

FIG. 12 is a block diagram illustrating the outline of the hardware configuration of the image processing apparatus. With reference to FIG. 12, the image processing apparatus 11 includes a hardware processor comprising a central processing unit (CPU) 13, a read only-memory (ROM) 14, a random access memory (RAM) 15, a storage device 16, and a communication section (or communication interface) 17. The CPU 13 is connected to the ROM 14, the RAM 15, and the storage device 16, and controls the image processing apparatus 11 as a whole.

The ROM 14 stores a program to be executed by the CPU 13 or data required for execution of the program. The RAM 15 is used as a working area for the CPU 13 when the CPU 13 executes the program.

The communication section 17 is an interface for connecting the image processing apparatus 11 to a network. The CPU 13 controls the communication section 17 to communicate with another computer, such as a server, connected to the network.

The storage device 16 is a mass storage device such as a solid state drive (SSD). Further, a CD-ROM 18 is mounted on the storage device 16. The CPU 13 can control the storage device 16 to access the CD-ROM 18. The CPU 13 loads a program recorded in the CD-ROM 18 into the RAM 15 and executes the program. A medium for storing the program to be executed by the CPU 13 is not limited to the CD-ROM 18 but may be an optical disc, an IC card, an optical card, or a semiconductor memory such as a mask ROM or an EPROM.

The CPU 13 may load the program stored in the storage device 16 into the RAM 15 and execute the program. The program stored in the storage device 16 includes a program downloaded by the CPU 13 from a computer connected to the Internet, or a program written in the storage device 16 by the computer connected to the Internet. The network includes a local area network and the Internet. The program referred to here includes not only a program directly executable by the CPU 13 but also a source program, a compressed program, an encrypted program, or the like.

It is noted that a recording medium for storing the program to be executed by the CPU 13 is not limited to the CD-ROM 18. It may be a medium such as a flexible disc, a cassette tape, an optical disc, an IC card, an optical card, a mask ROM, or a semiconductor memory. The optical disc includes a magnetic optical disc (MO), a mini disc (MD), or a digital versatile disc (DVD).

Instead of the CPU 13, a processor such as a micro processing unit (MPU) or a digital signal processor (DSP) may be used. Further, a processor such as a field programmable gate array (FPGA) or an application specific integrated circuit (ASIC) may be used instead of the CPU 13. Further, the CPU 13 may include a combination of two or more of the above-mentioned processors.

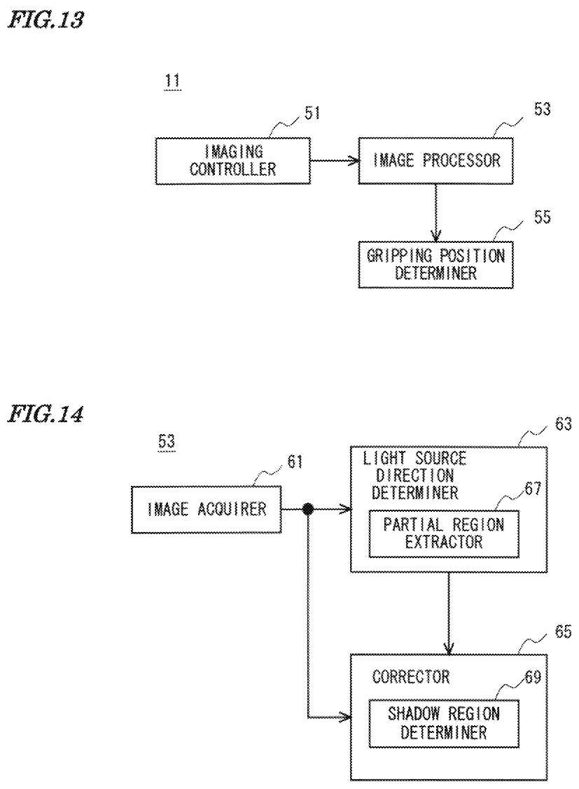

FIG. 13 is a block diagram illustrating one example of the functions of the CPU included in the image processing apparatus in the present embodiment. The functions illustrated in FIG. 13 are implemented by the CPU 13 included in the image processing apparatus 11 when the CPU 13 executes a shadow correction program stored in the ROM 14, the storage device 16, or the CD-ROM 18.

With reference to FIG. 13, the CPU 13 included in the image processing apparatus 11 includes an imaging controller 51, an image processor 53, and a gripping position determiner 55. The imaging controller 51 controls the camera 21, and receives the image 140 and distance data output by the camera 21. In a case where the seat track 100 is included in an imaging range of the camera 21, the image 140 includes an image of the seat track 100. The imaging controller 51 outputs the image 140 and the distance data received from the camera 21 to the image processor 53.

The image processor 53 corrects the image 140 received from the camera 21, and outputs a correction image obtained after the correction to the gripping position determiner 55.

The gripping position determiner 55 provides the correction image to a learning model, and determines a gripping position output by the learning model. The learning model uses a segmentation method such as segment anything model (SAM) using deep learning. With this learning model, an internal shape can be extracted, and center coordinates of the circular cutout portion 113 can be calculated by a unique algorithm. Alternatively, without using the learning model, the gripping position determiner 55 may extract an edge of an arc portion from the correction image, and approximate the edge with a circle to obtain the center coordinates of the circular cutout portion 113.

FIG. 14 is a diagram illustrating one example of the detailed functions of the image processor. With reference to FIG. 14, the image processor 53 includes an image acquirer 61, a light source direction determiner 63, and a corrector 65.

The image acquirer 61 acquires the image 140 output by the imaging controller 51. The image 140 output by the imaging controller 51 is an image that has been output by the camera 21 that images the subject. In response to acquisition of the image 140, the image acquirer 61 outputs the image 140 to the light source direction determiner 63 and the corrector 65.

Based on the image 140 received from the image acquirer 61, the light source direction determiner 63 determines, as a light source direction, a direction in which the light source is located. The light source direction determiner 63 includes a partial region extractor 67.

The partial region extractor 67 extracts a partial region 160 from the image 140. The partial region extractor 67 determines, as the partial region 160, a set of a plurality of pixels having luminance values equal to or higher than a predetermined threshold value. The threshold value is defined by a reflectance value of the first tapered surface 105. Because direct light has a higher reflectance value than scattered light, a pixel that receives the direct light has a higher luminance value than that of a pixel that receives only the scattered light. The pixel having a luminance value equal to or higher than the threshold value in the image 140 corresponds to a pixel that receives the direct light.

The first tapered surface 105 is formed to extend along the outer periphery of the circular cutout portion 113 of the seat track 100, and is inclined downwardly from the upper surface 101A toward the center of the circular cutout portion 113. Further, the first tapered surface 105 is mirror-finished. Therefore, the first tapered surface 105 includes a portion that reflects the light emitted from the light source as direct light. For this reason, the partial region 160 extracted from the image 140 by the partial region extractor 67 is a region where the light emitted from the light source appears in the image 140 as the direct light obtained by reflection from the first tapered surface 105.

Note that it is preferable to adjust an exposure time and a gain of the camera 21 such that the highest luminance value in the image 140 is 255, which is the maximum possible luminance value. This expands a dynamic range, which facilitates distinguishing between the direct light and the scattered light.

The light source direction determiner 63 determines a light source direction based on the partial region 160. Because the first tapered surface 105 is formed to extend along the outer periphery of the circular cutout portion 113, a portion of the first tapered surface 105 being in contact with the upper surface 101A has an arc shape. The partial region 160 is a region from which the camera 21 receives light reflected as the direct light from a portion of the first tapered surface 105. Therefore, the partial region 160 includes the arc portion 162 corresponding to the portion having the arc shape of the first tapered surface 105. The light source direction determiner 63 determines the reference axis orthogonal to the chord 161 of the arc portion 162 included in the partial region 160.

The light source direction determiner 63 determines either of the candidate directions parallel to the reference axis as the light source direction 170 based on a shape of the partial region 160 and the shape of the seat track 100. Here, the first tapered surface 105 is formed to extend along the outer periphery the circular cutout portion 113 of the seat track 100, and is inclined downwardly from the upper surface 101A toward the center of the circular cutout portion 113. Therefore, the light source direction determiner 63 determines, as the light source direction 170, the direction directed toward the center of the arc of the arc portion 162, out of the two directions serving as the candidate directions. The light source direction determiner 63 outputs the light source direction to the corrector 65.

The corrector 65 receives, from the image acquirer 61, the image 140 output by the camera 21, and receives the light source direction from the light source direction determiner 63. The corrector 65 includes a shadow region determiner 69. The shadow region determiner 69 determines a shadow region 150 based on luminance values of a plurality of pixels arranged in the light source directions among the plurality of pixels included in the image 140, and the shape of the seat track 100.

### Modification Example of Light Source Direction Determiner 63

The light source direction determiner 63 may extract a plurality of partial regions 160 respectively corresponding to the plurality of circular cutout portions 113 of the seat track 100, and determine a light source directions 170 based on the plurality of partial regions 160.

The plurality of circular cutout portions 113 are aligned in one direction. Therefore, light emitted from the light source reaches the plurality of first tapered surfaces 105 respectively corresponding to the plurality of circular cutout portions 113 in the same direction. For this reason, the light source direction determiner 63 determines the light source direction 170 such that light source directions 170 defined based on the plurality of partial regions 160 extracted from the image 140 are the same. Therefore, the light source direction 170 can be accurately determined.

FIG. 15 is a diagram for explaining determination and correction of the shadow region. With reference to FIG. 15, the upper diagram illustrates an image 140 output by the camera 21 and positions scanned by the camera 21 in the light source direction 170 in the image 140. In the lower diagram, a luminance profile is illustrated as a result of scanning in the light source direction 170. In the luminance profile, the luminance values of a plurality of pixels arranged in the light source direction among a plurality of pixels included in the image 140 are aligned in the order in which the plurality of pixels are aligned in the light source direction.

Pixels located at a position P1 to a position P2 correspond to pixels that receive scattered light obtained by reflection from the upper surface 101A. Their luminance values are 120. Pixels located at the position P2 to a position P3 correspond to pixels that receive direct light obtained by reflection from the first tapered surface 105. The pixels located at the position P2 to the position P3 are included in the partial region 160. Luminance values of the pixels located at the position P2 to the position P3 are the highest, which is 225.

Pixels located at the position P3 to a position P5 correspond to pixels that receive scattered light obtained by reflection from the bottom surface 102A. Among the pixels located at the position P3 to the position P5, pixels located at the position P4 to the position P5 are included in the shadow region 150. Luminance values of the pixels located at the position P4 to the position P5 are the lowest, that is, thirty. Among the pixels located at the position P3 to the position P5, luminance value of the pixels located at the positions P3 to P4 is 150.

Pixels located at the position P5 to a position P6 correspond to pixels that receive scattered light obtained by reflection from the first tapered surface 105 and the upper surface 101A. Luminance values of the pixels located at the position P5 to the position P6 are 120.

The shape of the seat track 100 is known. It is understood that, in a case where the image 140 is scanned in the light source direction 170, pixels are arranged such that the upper surface 101A, the first tapered surface 105, the bottom surface 102A, the first tapered surface 105, and the upper surface 101A are aligned in this order. It is also known that the shadow region 150 appears on the bottom surface 102A. For this reason, based on variations of the luminance values of the plurality of pixels obtained by scanning the image 140 output by the camera 21 in the light source direction 170, it is possible to determine that the shadow region 150 corresponds to the plurality of pixels belonging to the position P4 to the position P5. Furthermore, it is possible to determine that the bottom surface 102A corresponds to the plurality of pixels belonging to the position P3 to the position P4.

With reference back to FIG. 14, the corrector 65 corrects the shadow region 150 of the image 140. The corrector 65 replaces the shadow region 150 with a reference region 155 adjacent to the shadow region 150. In the present embodiment, the reference region 155 has a set of a plurality of pixels that receive scattered light reflected from the bottom surface 102A. In the example illustrated in FIG. 14, the corrector 65 replaces the luminance values of the plurality of pixels belonging to the position P4 to the position P5 included in the shadow region 150 with the luminance values of the plurality of pixels belonging to the position P3 to the position P4 included in the reference region 155. For example, the corrector 65 replaces the luminance values of the plurality of pixels belonging to the position P4 to the position P5 included in the shadow region 150 with a mean value of the luminance values of the plurality of pixels belonging to the position P3 to the position P4 included in the reference region 155.

### Modification Example of Correction of Shadow Region

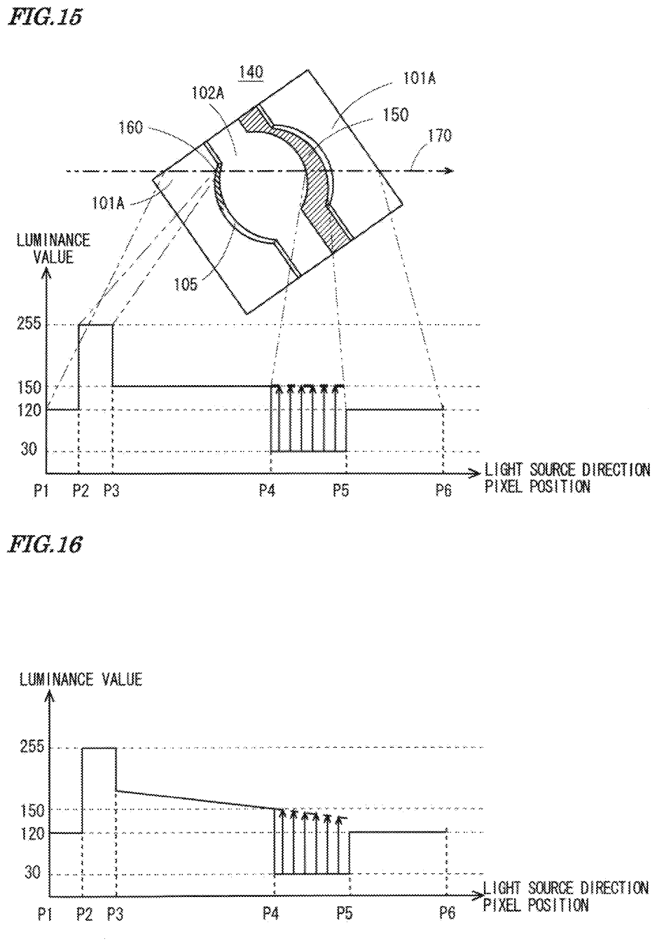

FIG. 16 is a diagram for explaining determination and correction of the shadow region in a modification example. With reference to FIG. 16 corresponding to the lower diagram illustrated in FIG. 15, as a result of scanning in the light source direction 170, pixels (luminance values) respectively corresponding to the positions of the plurality of pixels are illustrated. The difference from the luminance values illustrated in FIG. 15 is that, among the plurality of pixels located at the position P3 to the position P4, the luminance value of the pixel located at the position P4 has the highest luminance value, and the closer a pixel is to the position P4, the lower a luminance value. In this case, a search region is set at the positions P3 to the position P4, and the luminance values belonging to the partial region 160 are corrected based on a distribution of the luminance values in the search region. Specifically, the luminance values of the plurality of pixels located at the position P4 to the position P5 are changed to the luminance values of the plurality of pixels having the same distribution as the distribution of the luminance values of the plurality of pixels located at the position P3 to P4. Thus, the distribution of the luminance values in the search region can be made similar to the distribution of the luminance values in the shadow region. Furthermore, it is possible to prevent the boundary between the search region and the partial region 160 from being extracted as an edge.

### Modification Example in a case Where Plurality of Light Sources are Present

There may be a plurality of light sources. A first light source and a second light source are present, by way of example. The seat track 100 reflects light emitted from each of the first light source and the second light source. The light source direction determiner 63 extracts a first partial region 165 corresponding to the first light source and a second partial region 166 corresponding to the second light source. The light source direction determiner 63 determines a first light source direction 170A corresponding to the first partial region 165, and determines a second light source direction 170B corresponding to the second partial region 166.
(1) The corrector 65 corrects the shadow region 150 in the image 140 based on the first light source direction 170A and the shape of the seat track 100 to generate a corrected image, and then corrects the shadow region 150 in the corrected image based on the second light source direction 170B and the shape of the seat track 100, thereby generating a correction image. Therefore, it is possible to correct shadow regions created by the plurality of light sources.
(2) The light source direction determiner 63 determines, as the light source direction 170, either of the first light source direction 170A corresponding to the first partial region 165 and the second light source direction 170B corresponding to the second partial region 166.

A shadow is generated in a portion not irradiated with any of a plurality of light beams respectively emitted from the first light source and the second light source. Therefore, the shadow region 150 in the image 140 can be corrected by correcting a portion corresponding to a shadow, with the shadow corresponding to either of the first light source direction 170A and the second light source direction 170B.
(3) The light source direction determiner 63 determines, as the light source direction 170, a direction obtained by combining the first light source direction 170A corresponding to the first partial region 165 and the second light source direction 170B corresponding to the second partial region 166. The corrector 65 generates a correction image by correcting the shadow region 150 in the image 140 based on the light source direction 170 and the shape of the seat track 100. A shadow is generated in a portion not irradiated with any of a plurality of light beams respectively emitted from the first light source and the second light source. Therefore, the shadow region 150 in the image 140 can be corrected by correcting a portion corresponding to the shadow, with the shadow corresponding to the light source direction 170 obtained by combining the first light source direction 170A and the second light source direction 170b.

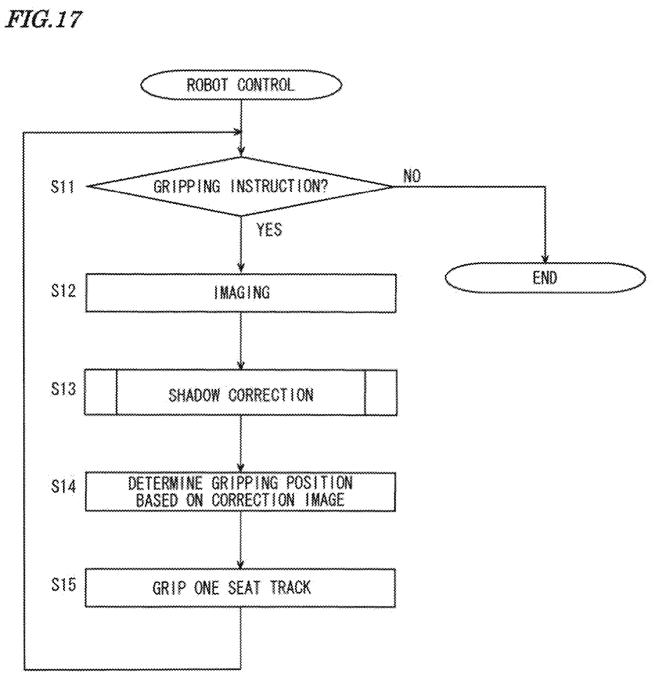

FIG. 17 is a flowchart illustrating one example of a robot control process in the present embodiment. The robot control process is executed by the CPU 13 included in the image processing apparatus 11 when the CPU 13 executes a robot control program stored in the ROM 14, the storage device 16, or the CD-ROM 18.

With reference to FIG. 17, the CPU 13 included in the image processing apparatus 11 determines whether a gripping instruction has been accepted (step S11). The CPU 13 accepts the gripping instruction in response to an occurrence of a certain trigger event. The CPU 13 accepts the gripping instruction based on the trigger event received from outside. The CPU 13 may receive a tripper event from another application program. If the gripping instruction has been accepted, the process proceeds to the step S12. If not, the process ends.

In the step S12, the CPU 13 captures an image of the seat track 100, and the process proceeds to the step S13. The CPU 13 controls the camera 21, causes the camera 21 to capture an image of the seat track 100, and measures a distance to the seat track 100. The CPU 13 acquires, from the camera 21, the image 140 obtained by imaging the seat track 100, and acquires distance data representing the distance to the seat track 100.

In the step S13, the CPU 13 executes a shadow correction process, and the process proceeds to the step S14. The shadow correction process, which will be described below in more detail, is a process of generating a correction image by correcting the image 140 such that the shadow region 150 is removed from the image 140.

In the step S14, the CPU 13 determines a gripping position, and the process proceeds to the step S15. The CPU 13 transmits a correction image to a learning model prepared in advance, and acquires center coordinates of a circular portion that are output by a learning model. The center coordinates indicate a position in the image 140 and the center of the circular cutout portion 113 included in the image 140. At the gripping position, the hand of the articulated robot 35 grips the seat track 100. The gripping position is located at the center of the circular cutout portion 113 of the seat track 100. The center coordinates determined in the step S14 indicate a position in a coordinate system of the camera 21. Because the relative position of the camera 21 and the articulated robot 35 is fixed, the relationship between the coordinate system of the camera 21 and a coordinate system of the articulated robot 35 is known. The CPU 13 determines the gripping position in the coordinate system of the articulated robot 35 based on the coordinates of the center of the circular cutout portion 113 in the correction image and the distance to the seat track 100 acquired in the step S12.

In the step S15, the CPU 13 causes the articulated robot 35 to grip the sheet guideseat track 100, and the process returns to the step S11. The CPU 13 outputs a command including the gripping position to the controller 33. The controller 33 executes the command to control the articulated robot 35, moves the hand to the gripping position, and causes the hand to grip the seat track 100.

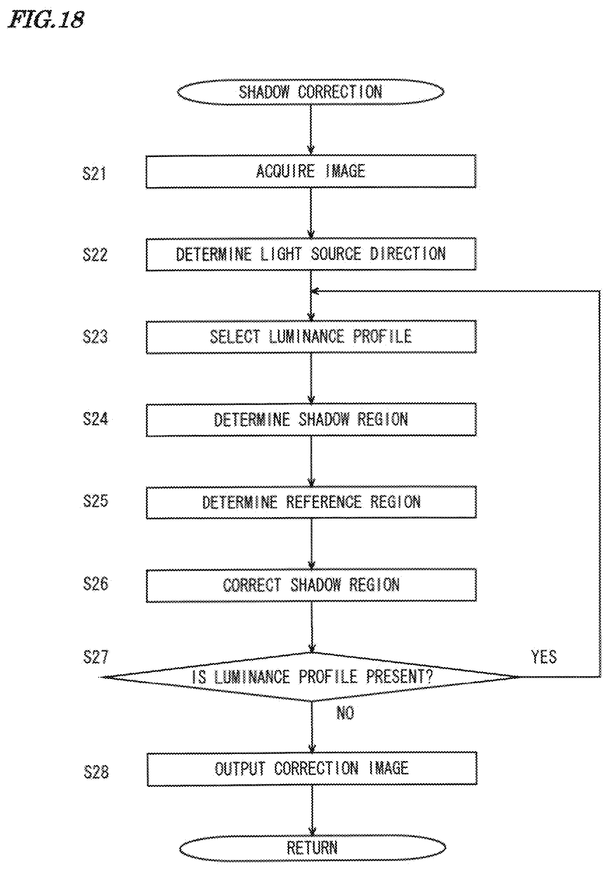

FIG. 18 is a flowchart illustrating one example of a flow of the shadow correction process. The shadow correction process is executed by the CPU 13 included in the image processing apparatus 11 when the CPU 13 executes the shadow correction program stored in the ROM 14, the storage device 16, or the CD-ROM 18. With reference to FIG. 18, the CPU 13 acquires the image 140 output by the camera 21 (step S21), and the process proceeds to the S22.

In the step S22, the CPU 13 determines a light source direction based on the image 140, and the process proceeds to the step S23. The CPU 13 extracts the partial region 160 from the image 140. Specifically, the CPU 13 determines, as the partial region 160, a set of a plurality of pixels having luminance values equal to or higher than the predetermined threshold value in the image 140. The CPU 13 determines, as the reference axis, a direction orthogonal to the chord 161 of the arc portion 162 included in the partial region 160. Furthermore, the CPU 13 determines a direction passing through a center of the arc portion 162 as the light source direction.

In the step S23, the CPU 13 selects a luminance profile from the image 140. In the luminance profile, among a plurality of pixels included in the image 140, luminance values of a plurality of pixels arranged in the light source direction are aligned in the order in which the plurality of pixels are aligned in the light source direction. Since there are a plurality of luminance profiles, one of them is selected as a processing subject.

In the step S24, the shadow region is determined. Based on variations of the luminance values of the luminance profile, a portion of the luminance profile corresponding to the shadow region 150 is determined. In the seat track 100, the upper surface 101A, the first tapered surface 105, the bottom surface 102A, the first tapered surface 105, and the upper surface 101A are arranged in this order in the light source direction. By determining in advance a possible range of luminance values respectively corresponding to portions in the image 140, a portion having a luminance value not corresponding to any portion is identified as the shadow region.

In the step S25, the CPU 13 determines the reference region, and the process proceeds to the step S26. The reference region corresponds to the bottom surface 102A in the luminance profile, and is not included in the shadow region.

In the step S26, the CPU 13 corrects the shadow region, and the process proceeds to the step S27. The CPU 13 replaces a luminance value of a pixel in the shadow region of the luminance profile with a mean value of luminance values of a plurality of pixels included in the reference region.

In the step S27, it is determined whether a luminance profile not selected as a processing subject is present. If an unselected luminance profile is present, the process returns to the step S23. If not, the process returns to the robot control process.

### Another Modification Example

In the above-mentioned embodiment, the mobile robot 10 includes the image processing apparatus 11, by way of example. The image processor 53 and the gripping position determiner 55 included in the image processing apparatus 11 may be included in an apparatus different from the mobile robot 10. For example, a computer such as a server capable of communicating wirelessly with the mobile robot 10 may include the image processor 53 and the gripping position determiner 55. The mobile robot 10 may communicate with the server to transmit the image 140 captured by the camera 21 to the server and receive a gripping position and a distance from the server. Further, the server may include either of the image processor 53 and the gripping position determiner 55, and the mobile robot 10 may include the other one of the image processor 53 and the gripping position determiner 55. In a case where the mobile robot 10 includes the image processor 53, and the server includes the gripping position determiner 55, the mobile robot 10 transmits a correction image to the server and receives the gripping position and the distance from the server. In a case where the server includes the image processor 53, and the mobile robot 10 includes the gripping position determiner 55, the mobile robot 10 transmits the image 140 output by the camera 21 to the server and receives the correction image from the server. The mobile robot 10 provides the correction image to a learning model to determine the gripping position.

### Overview of Embodiment

(Item 1) An image processing apparatus includes a hardware processor, wherein the hardware processor acquires an image obtained by imaging an object, with the object having an upper surface and having an arc-shaped opening formed in a portion of the upper surface, and corrects a shadow region appearing as a shadow in the acquired image.

According to this aspect, the shadow region appearing as the shadow in the image obtained by imaging the object having the arc-shaped opening in the portion of the upper surface is corrected. Therefore, it is possible to provide the image processing apparatus capable of generating an image in which the accuracy of a process of extracting a portion where the subject appears from the image is improved.

(Item 2) The image processing apparatus according to item 1, wherein the hardware processor determines, as a light source direction, a direction in which a light source is located, and in correcting the shadow region, corrects the shadow region based on the light source direction and a shape of the object.

According to this aspect, the light source direction is determined, and the shadow region is corrected based on the light source direction and the shape of the object. Because the shape of the shadow region is determined by the shape of the object and the light source direction, the shadow region in the image can be identified.

(Item 3) The image processing apparatus according to item 2, wherein a tapered surface inclined downwardly from the upper surface toward a center in a radial direction is formed to extend along an outer periphery of the opening of the object, and the hardware processor, in determining the direction in which the light source is located, extracts a partial region appearing in the image as direct light obtained by reflection, from the tapered surface, of light emitted from the light source.

According to this aspect, the partial region where light emitted from the light source appears in the image as the direct light reflected from the tapered surface is extracted. The tapered surface is formed to extend along the outer periphery of the opening of the object and is inclined downwardly toward the center of the opening from the upper surface. Therefore, the partial region includes an arc shape corresponding to an edge portion of the opening. For this reason, the light source direction can be determined based on the arc shape of the partial region.

(Item 4) The image processing apparatus according to item 3, wherein the hardware processor, in determining the direction in which the light source is located, determines, as the partial region, a set of a plurality of pixels having luminance values equal to or higher than a threshold value defined by a reflectance value of the tapered surface.

According to this aspect, the set of plurality of pixels having luminance values equal to or higher than the threshold value defined by the reflectance value of the tapered surface is determined as the partial region. Because direct light has a higher reflectance value than scattered light, a pixel that receives the direct light has a higher luminance value than that of a pixel that receives only the scattered light. Therefore, pixels having the luminance values equal to or higher than the threshold value defined by the reflectance value of the tapered surface are extracted, which enables extraction of the partial region appearing in the image as the direct light.

(Item 5) The image processing apparatus according to item 3 or 4, wherein the hardware processor, in determining the direction in which the light source is located, determines a reference axis orthogonal to a chord having an arc shape and included in the partial region.

According to this aspect, two directions parallel to the reference axis orthogonal to the chord of the arc shape included in the partial region are determined as the candidate directions. The partial region includes a portion having an arc shape because light emitted from the light source in one direction is reflected from the tapered surface having an arc shape. The axis orthogonal to the chord of the arc is determined as the reference axis parallel to the light source direction. Therefore, the light source direction can be accurately determined.

(Item 6) The image processing apparatus according to item 5, wherein the hardware processor, in determining the direction in which the light source is located, determines either of two candidate directions parallel to the reference axis as the light source direction based on a shape of the partial region and a shape of the object.

According to this aspect, one of the two candidate directions is determined as the light source direction, based on the shape of the partial region and the shape of the object.

(Item 7) The image processing apparatus according to any one of items 3 to 6, wherein the hardware processor, in determining the direction in which the light source is located, in a case where a plurality of the partial regions are extracted, determines a plurality of the light source directions respectively corresponding to the plurality of the partial regions, and in correcting the shadow region, corrects the shadow region based on the plurality of the respective light source directions and the shape of the object.

According to this aspect, in a case where the plurality of partial regions are extracted, the plurality of light source directions respectively corresponding to the plurality of partial regions are determined, and the shadow region is corrected based on the plurality of respective light source directions and the shape of the object. Therefore, it is possible to correct the shadow region created by the plurality of respective light sources.

(Item 8) The image processing apparatus according to any one of items 3 to 6, wherein the hardware processor, in determining the direction in which the light source is located, in a case where a plurality of the partial regions are extracted, selects one of the plurality of the partial regions and determines the light source direction corresponding to the selected partial region as the light source direction.

According to this aspect, in a case where the plurality of partial regions are extracted, the light source direction corresponding to one partial region selected from among the plurality of partial regions is determined. A shadow is generated in a portion not irradiated with any of a plurality of light beams emitted from the plurality of light sources. Therefore, the shadow region in the image can be corrected by correcting the image based on the plurality of light source directions.

(Item 9) The image processing apparatus according to any one of items 3 to 6, wherein the hardware processor, in determining the direction in which the light source is located, in a case where a plurality of the partial regions are extracted, determines a plurality of the light source directions respectively corresponding to the plurality of the partial regions, and in correcting the shadow region, corrects the shadow region based on a direction obtained by combining the plurality of the light source directions, and a shape of the object.

According to this aspect, in a case where the plurality of partial regions are extracted, the plurality of light source directions respectively corresponding to the plurality of partial regions are determined, and the shadow region is corrected based on the direction obtained by combining the plurality of light source directions, and the shape of the object. A shadow is generated in a portion not irradiated with any of a plurality of light beams emitted from the plurality of light sources. Therefore, the shadow region in the image can be corrected by correcting the image based on the direction obtained by combining the plurality of light source directions.

(Item 10) The image processing apparatus according to any one of items 3 to 9, wherein the hardware processor, in determining the direction in which the light source is located, in a case where the object includes a plurality of the openings and the plurality of the openings are regularly aligned, extracts a plurality of the partial regions respectively corresponding to the plurality of the openings and determines the light source direction based on the plurality of the partial regions.

According to this aspect, in a case where the object includes the plurality of regularly aligned openings, the plurality of partial regions respectively corresponding to the plurality of openings are extracted, and the light source direction is determined based on the plurality of partial regions. Light emitted from the light source reaches each of the plurality of openings in the same direction. Therefore, the light source direction is determined such that the light source directions defined based on the plurality of partial regions are the same direction. Thus, the light source direction can be accurately determined.

(Item 11) The image processing apparatus according to any one of items 3 to 10, wherein the hardware processor, in determining the direction in which the light source is located, in a case where the partial region includes an end portion of the opening, extends the partial region toward the end portion.

According to this aspect, in a case where the partial region includes the end portion of the opening, the partial region is extended toward the end portion. Because the opening is an arc, a portion to be extracted as the partial region in a case of a circle is not extracted as the partial region. Therefore, a portion to be extracted as the partial region in a case where the opening is a circle is complemented by extending the partial region. Thus, the light source direction can be accurately determined.

(Item 12) The image processing apparatus according to any one of items 2 to 11, wherein the hardware processor, in correcting the shadow region, determines the shadow region based on luminance values of a plurality of pixels aligned in the light source direction among a plurality of pixels included in the image, and a shape of the object.

According to this aspect, the shadow region is determined based on the luminance values of the plurality of pixels arranged in the light source direction, and the shape of the object. Therefore, the shadow region can be accurately determined.

(Item 13) The image processing apparatus according to any one of items 2 to 12, wherein the hardware processor, in correcting the shadow region, sets a plurality of adjacent pixels among a plurality of pixels arranged in the light source direction as a search region, and corrects the shadow region based on a distribution of luminance values of the plurality of adjacent pixels in the search region.

According to this aspect, the shadow region is corrected based on the distribution of the luminance values of the plurality of pixels in the search region. Therefore, the distribution of the luminance values of the search region can be made similar to the distribution of the luminance values of the shadow region.

(Item 14) The image processing apparatus according to any one of items 1 to 13, wherein the hardware processor, in correcting the shadow region, replaces the shadow region with a reference region adjacent to the shadow region.

According to this aspect, because the shadow region is replaced with the adjacent reference region, the boundary between the shadow region and the reference region can be removed.

(Item 15) The image processing apparatus according to item 14, wherein the reference region corresponds to the opening of the object.

According to this aspect, the reference region corresponds to the region of the opening in the object. Because a shadow is generated in the opening, all of the openings can have similar luminance values.

(Item 16) The image processing apparatus according to any one of items 1 to 15, wherein the hardware processor further provides, to a learning model, a correction image obtained after the shadow region is corrected in correcting the shadow region, and determines a position of the opening in the correction image.

According to this aspect, the position of the opening in the correction image is determined based on the correction image, with the correction image being obtained after the shadow region is corrected by the learning model. Therefore, the specific position of the object can be easily determined.

(Item 17) The image processing apparatus according to any one of items 1 to 16, wherein the object is a seat track, and the opening is a portion forming a lug nut of the seat track.

According to this aspect, it is possible to correct a shadow region that appears in the portion corresponding to the lug nut based on an image obtained by imaging the seat track.

(Item 18) A mobile robot includes the image processing apparatus according to any one of items 1 to 15, an imager that images an object, a manipulator that grips the object, and an apparatus hardware processor, wherein the apparatus hardware processor provides, to a learning model, a correction image obtained after a shadow region is corrected by the image processing apparatus, and determines a position of an opening in the correction image.

According to this aspect, the shadow region appearing in the image obtained by the imager imaging the object is corrected by the image processing apparatus, and the position of the opening in the correction image obtained by correcting the shadow region is determined by the learning model. Because the position of the opening in the correction image is determined, the manipulator can grip the object. As a result, it is possible to provide the mobile robot capable of causing the manipulator to reliably grip the object.

(Item 19) A shadow correction method causes an image processing apparatus to execute an image acquiring step of acquiring an image obtained by imaging an object, with the object having an upper surface and having an arc-shaped opening formed in a portion of the upper surface, and a correcting step of correcting a shadow region appearing as a shadow in the acquired image.

According to this aspect, it is possible to provide the image processing method with which the portion in which the object appears is extracted from the image with improved accuracy.

(Item 20) The shadow correction method according to item 19, further includes a position determining step of providing, to a learning model, a correction image obtained after the shadow region is corrected in the correcting step, and determining a position of the opening in the image.

According to this aspect, the specific position of the object can be easily determined.

(Item 21) A non-transitory computer-readable recording medium is encoded with a shadow correction program that causes a computer to execute the shadow correction method according to item 19 or 20.

According to this aspect, it is possible to provide the shadow correction program with which the portion in which the object appears is extracted from the image with improved accuracy.

It should be understood that the embodiments disclosed herein are illustrative and non-restrictive in every respect. The scope of the present invention is defined not by the above description but by the appended claims, and is intended to include any modifications within the scope and meaning equivalent to the appended claims.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image processing apparatus comprising a hardware processor,
the hardware processor:
acquiring an image obtained by imaging an object, the object having an upper surface and having an arc-shaped opening formed in a portion of the upper surface; and
correcting a shadow region appearing as a shadow in the acquired image.

2. The image processing apparatus according to claim 1, wherein
the hardware processor
determines, as a light source direction, a direction in which a light source is located, and
in correcting the shadow region, corrects the shadow region based on the light source direction and a shape of the object.

3. The image processing apparatus according to claim 2, wherein
a tapered surface inclined downwardly from the upper surface toward a center in a radial direction is formed to extend along an outer periphery of the opening of the object, and
the hardware processor, in determining the direction in which the light source is located, extracts a partial region appearing in the image as direct light obtained by reflection, from the tapered surface, of light emitted from the light source.

4. The image processing apparatus according to claim 3, wherein
the hardware processor, in determining the direction in which the light source is located, determines, as the partial region, a set of a plurality of pixels having luminance values equal to or higher than a threshold value defined by a reflectance value of the tapered surface.

5. The image processing apparatus according to claim 3, wherein
the hardware processor, in determining the direction in which the light source is located, determines a reference axis orthogonal to a chord having an arc shape and included in the partial region.

6. The image processing apparatus according to claim 5, wherein
the hardware processor, in determining the direction in which the light source is located, determines either of two candidate directions parallel to the reference axis as the light source direction based on a shape of the partial region and a shape of the object.

7. The image processing apparatus according to claim 3, wherein
the hardware processor,
in determining the direction in which the light source is located, in a case where a plurality of the partial regions are extracted, determines a plurality of the light source directions respectively corresponding to the plurality of the partial regions, and
in correcting the shadow region, corrects the shadow region based on the plurality of the respective light source directions and the shape of the object.

8. The image processing apparatus according to claim 3, wherein
the hardware processor, in determining the direction in which the light source is located, in a case where a plurality of the partial regions are extracted, selects one of the plurality of the partial regions and determines the light source direction corresponding to the selected partial region as the light source direction.

9. The image processing apparatus according to claim 3, wherein
the hardware processor,
in determining the direction in which the light source is located, in a case where a plurality of the partial regions are extracted, determines a plurality of the light source directions respectively corresponding to the plurality of the partial regions, and
in correcting the shadow region, corrects the shadow region based on a direction obtained by combining the plurality of the light source directions, and a shape of the object.

10. The image processing apparatus according to claim 3, wherein
the hardware processor, in determining the direction in which light is emitted from the light source is located, in a case where the object includes a plurality of the openings and the plurality of the openings are regularly aligned, extracts a plurality of the partial regions respectively corresponding to the plurality of the openings and determines the light source direction based on the plurality of the partial regions.

11. The image processing apparatus according to claim 3, wherein
the hardware processor, in determining the direction in which the light source is located, in a case where the partial region includes an end portion of the opening, extends the partial region toward the end portion.

12. The image processing apparatus according to claim 2, wherein
the hardware processor, in correcting the shadow region, determines the shadow region based on luminance values of a plurality of pixels aligned in the light source direction among a plurality of pixels included in the image, and a shape of the object.

13. The image processing apparatus according to claim 2, wherein
the hardware processor, in correcting the shadow region, sets a plurality of adjacent pixels among a plurality of pixels arranged in the light source direction as a search region, and corrects the shadow region based on a distribution of luminance values of the plurality of adjacent pixels in the search region.

14. The image processing apparatus according to claim 2, wherein
the hardware processor, in correcting the shadow region, replaces the shadow region with a reference region adjacent to the shadow region.

15. The image processing apparatus according to claim 14, wherein
the reference region corresponds to the opening of the object.

16. The image processing apparatus according to claim 1, wherein
the hardware processor further provides, to a learning model, a correction image obtained after the shadow region is corrected in correcting the shadow region, and determines a position of the opening in the correction image.

17. The image processing apparatus according to claim 1, wherein
the object is a seat track, and
the opening is a portion forming a lug nut of the seat track.

18. A mobile robot comprising:
the image processing apparatus according to claim 1;
an imager that images an object;
a manipulator that grips the object; and
an apparatus hardware processor, wherein
the apparatus hardware processor provides, to a learning model, a correction image obtained after a shadow region is corrected by the image processing apparatus, and determines a position of an opening in the correction image.

19. A shadow correction method that causes an image processing apparatus to execute:
an image acquiring step of acquiring an image obtained by imaging an object, the object having an upper surface and having an arc-shaped opening formed in a portion of the upper surface; and
a correcting step of correcting a shadow region appearing as a shadow in the acquired image.

20. The shadow correction method according to claim 19, further including a position determining step of providing, to a learning model, a correction image obtained after the shadow region is corrected in the correcting step, and determining a position of the opening in the image.

21. A non-transitory computer-readable recording medium encoded with a shadow correction program that causes a computer to execute the shadow correction method according to claim 19.
